(19) United States
(12) Patent Application Publication
(10) Pub. No.: US 2025/0071615 A1
(43) Pub. Date: Feb. 27, 2025

(54) DATA TRANSMISSION METHOD AND APPARATUS AND COMMUNICATION DEVICE

(71) Applicant: VIVO MOBILE COMMUNICATION CO., LTD., Dongguan (CN)

(72) Inventors: Yannan YUAN, Dongguan (CN); Xiaodong YANG, Dongguan (CN); Boubacar KIMBA DIT ADAMOU, Dongguan (CN)

(73) Assignee: VIVO MOBILE COMMUNICATION CO., LTD., Dongguan (CN)

(21) Appl. No.: 18/943,736

(22) Filed: Nov. 11, 2024

Related U.S. Application Data
(63) Continuation of application No. PCT/CN2023/092426, filed on May 6, 2023.

(30) Foreign Application Priority Data
May 9, 2022 (CN) 202210503527.0

(51) Int. Cl. H04W 28/06; H04W 28/24

(52) U.S. Cl. CPC H04W 28/06; H04W 28/24

(57) ABSTRACT

A data transmission method and a communication device are disclosed. The data transmission method includes: obtaining, by an access network device, a data characteristic of to-be-transmitted data, where the data characteristic includes at least one of the following: a data size characteristic or a characteristic of relationship between data packets; and performing, by the access network device, a first operation according to the data characteristic of the to-be-transmitted data.

### CROSS-REFERENCE TO RELATED APPLICATIONS

This application is a continuation of International Application No. PCT/CN2023/092426, filed on May 6, 2023, which claims priority to Chinese Patent Application No. 202210503527.0, filed May 9, 2022. The entire contents of each of the above-identified applications are expressly incorporated herein by reference.

### TECHNICAL FIELD

This application pertains to the field of wireless communication technologies, and specifically, relates to a data transmission method and apparatus and a communication device.

### BACKGROUND

The protocol design of related communication networks mainly targets service data transmission with various unknown data characteristics and is based on the basic premise of limited air interface resources and maximizing the utilization rate of air interface resources. Since the size of the received data packet is unknown, and the data size for by the Media Access Control (MAC) grant transmission each tine is also dynamic, the segmentation and resegmentation of the Radio Link Control (RLC) and MAC layer in the fourth-generation mobile communication technology (4th Generation Mobile Communication Technology, 4G)/fifth-generation mobile communication technology (5th Generation Mobile Communication Technology, 5G) protocols are all to configure data packets of variable length and dynamically changing data sizes for MAC grant transmission. Meanwhile, data transmission in mobile communication networks also needs to meet requirements such as rate, delay, and packet error rate. Therefore, 5G protocol optimization (the RLC constructs RLC Protocol Data Unit (PDU) directly without waiting for transmission opportunities indicated by the MAC layer; and the RLC layer removes the RLC Service Data Unit (SDU) concatenation function and the RLC reordering function) is mainly aimed at shortening protocol processing time to meet the Quality of Service (QoS) requirements. If it is still necessary to consider both the flexible service data sizes and sizes of data that can be dynamically transmitted over the air interface, the space for protocol optimization remains very limited. For example, for packet header compression of small packets, if the preceding flexibility is to be retained, the space for compressing the information in the packet header is very limited, RLC still needs to perform segmentation, and MAC still needs to concatenate multiple RLC PDUs of multiple logical channels. To improve air interface efficiency, MAC still needs to perform multiplexing and demultiplexing of data on multiple logical channels according to sizes of data blocks that can be transmitted on the air interface. To ensure the bit error rate and continuity of user-plane data transmission, RLC and MAC need to request retransmission through Automatic Repeat reQuest (ARQ) or Hybrid Automatic Repeat reQuest (HARQ) to guarantee correct data transmission. During the handover process, a source base station and a target base station need to exchange uncompleted transmission data to ensure data continuity. In addition, the sixth generation (6^{th} Generation, 6G) demands higher requirements for protocol complexity and communication performance, that is, requiring both intelligent/light networks and ultimate performance. Continuing with the independent design of service and communication protocols may lead to higher communication overheads (for example, larger spectrum bandwidth and greater total power consumption). Furthermore, services within the network may also increase, so there is an urgent need for a universal solution to meet the requirements of quality of service assurance for all potential new services.

### SUMMARY

Embodiments of this application provide a data transmission method and apparatus and a communication device.

According to a first aspect, a data transmission method is provided and includes:
obtaining, an access network device, a data characteristic of to-be-transmitted data, where the data characteristic includes at least one of the following: a data size characteristic and a characteristic of relationship between data packets; and
performing, by the access network device, a first operation according to the data characteristic of the to-be-transmitted data.

According to a second aspect, a data transmission method is provided and includes:
obtaining, by a terminal, a data characteristic of to-be-transmitted data, where the data characteristic includes at least one of the following: a data size characteristic and a characteristic of relationship between data packets; and
performing, by the terminal, a second operation according to the data characteristic of the to-be-transmitted data.

According to a third aspect, a data transmission method is provided and includes:
sending, by a core network device, a data characteristic of to-be-transmitted data, or sending a data characteristic recommendation request for to-be-transmitted data on a target plane; where
the data characteristic includes at least one of the following: a data size characteristic and a characteristic of relationship between data packets; and
the target plane is a protocol function plane for supporting at least one of data collection, data distribution, data security, data privacy, data analysis, and data preprocessing.

According to a fourth aspect, a data transmission apparatus is provided and includes:
an obtaining module, configured to obtain a data characteristic of to-be-transmitted data, where the data characteristic includes at least one of the following: a data size characteristic and a characteristic of relationship between data packets; and
an execution module, configured to perform a first operation according to the data characteristic of the to-be-transmitted data.

According to a fifth aspect, a data transmission apparatus is provided and includes:
an obtaining module, configured to obtain a data characteristic of to-be-transmitted data, where the data characteristic includes at least one of the following: a data size characteristic and a characteristic of relationship between data packets; and
an execution module, configured to perform a second operation according to the data characteristic of the to-be-transmitted data.

According to a sixth aspect, a data transmission apparatus is provided and includes:
a sending module, configured to send a data characteristic of to-be-transmitted data or send a data characteristic recommendation request for to-be-transmitted data on a target plane; where
the data characteristic includes at least one of the following: a data size characteristic and a characteristic of relationship between data packets; and
the target plane is a protocol function plane for supporting at least one of data collection, data distribution, data security, data privacy, data analysis, and data preprocessing.

According to a seventh aspect, a communication device is provided, where the communication device includes a processor and a memory, the memory stores a program or instructions capable of running on the processor, and when the program or instructions are executed by the processor, the steps of the method according to the first aspect, the second aspect, or the third aspect are implemented.

According to an eighth aspect, an access network device is provided and includes a processor and a communication interface, where the processor is configured to: obtain a data characteristic of to-be-transmitted data, where the data characteristic includes at least one of the following: a data size characteristic and a characteristic of relationship between data packets; and perform a first operation according to the data characteristic of the to-be-transmitted data.

According to a ninth aspect, a terminal is provided and includes a processor and a communication interface, where the processor is configured to: obtain a data characteristic of to-be-transmitted data, where the data characteristic includes at least one of the following: a data size characteristic and a characteristic of relationship between data packets; and perform a second operation according to the data characteristic of the to-be-transmitted data.

According to a tenth aspect, a core network device is provided and includes a processor and a communication interface, where the communication interface is configured to send a data characteristic of to-be-transmitted data or send a data characteristic recommendation request for to-be-transmitted data on a target plane; where the data characteristic includes at least one of the following: a data size characteristic and a characteristic of relationship between data packets; and the target plane is a protocol function plane for supporting at least one of data collection, data distribution, data security, data privacy, data analysis, and data preprocessing.

According to an eleventh aspect, a communication system is provided and includes an access network device, a terminal, and a core network device, where the access network device may be configured to perform the steps of the data transmission method according to the first aspect, the terminal may be configured to perform the steps of the data transmission method according to the second aspect, and the core network device may be configured to perform the steps of the data transmission method according to the third aspect.

According to a twelfth aspect, a readable storage medium is provided, where the readable storage medium stores a program or instructions, and when the program or instructions are executed by a processor, the steps of the data transmission method according to the first aspect, the second aspect, or the third aspect are implemented.

According to a thirteenth aspect, a chip is provided, where the chip includes a processor and a communication interface, the communication interface is coupled to the processor, and the processor is configured to run a program or instructions to implement the steps of the data transmission method according to the first aspect, the second aspect, or the third aspect.

According to a fourteenth aspect, a computer program/program product is provided, where the computer program/program product is stored in a storage medium, and the computer program/program product is executed by at least one processor to implement the steps of the data transmission method according to the first aspect, the second aspect, or the third aspect.

In the embodiments of this application, a radio access network side may obtain a data characteristic of to-be-transmitted data, and the radio access network side performs a corresponding operation based on the data characteristic of the to-be-transmitted data.

### BRIEF DESCRIPTION OF DRAWINGS

FIG. 1A is a block diagram of a wireless communication system according to some implementations of this application;

FIG. 1B is a schematic diagram of mapping service layer SLA indicators to network layer SLA indicators;

FIG. 2 is a flowchart of a data transmission method performed by an access network device according to some implementations of this application;

FIG. 3 is a flowchart of a data transmission method performed by a terminal according to some implementations of this application;

FIG. 4 is a flowchart of a data transmission method performed by a core network device according to some implementations of this application;

FIG. 5 is a first block diagram of a data transmission apparatus according to some implementations of this application;

FIG. 6 is a second block diagram of a data transmission apparatus according to some implementations of this application;

FIG. 7 is a third block diagram of a data transmission apparatus according to some implementations of this application;

FIG. 8 is a block diagram of a communication device according to some implementations of this application;

FIG. 9 is a block diagram of a terminal according to some implementations of this application;

FIG. 10 is a first block diagram of a network-side device according to some implementations of this application; and

FIG. 11 is a second block diagram of a network-side device according to some implementations of this application.

### DETAILED DESCRIPTION

The following describes the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first,” “second,” and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or multiple first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the sixth generation (6^{th} Generation, 6G) communication system.

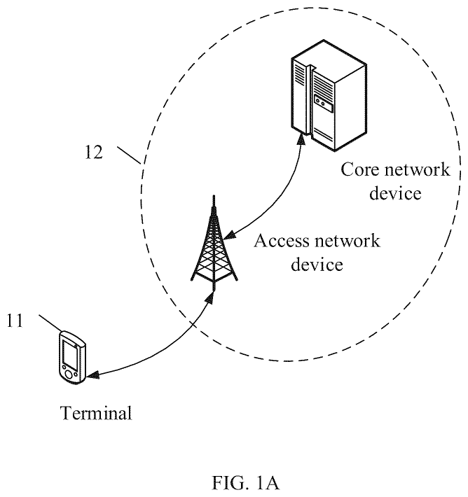

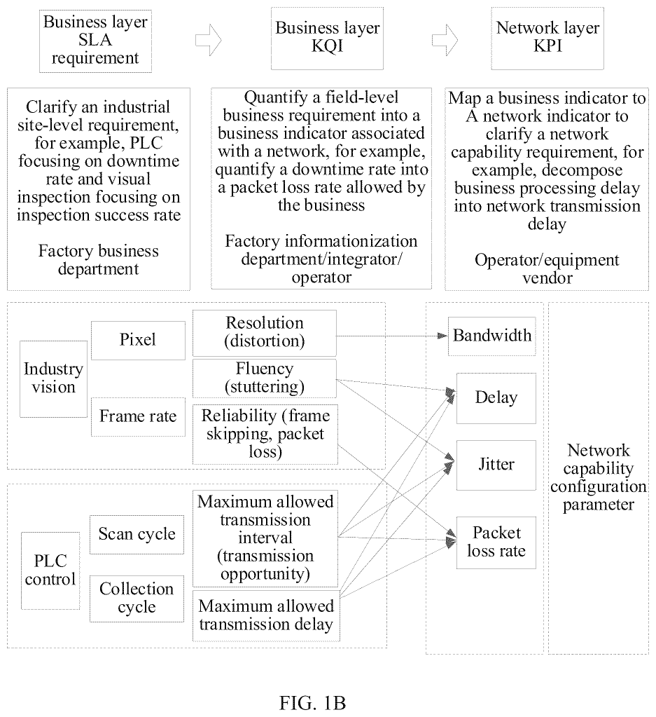

FIG. 1A is a block diagram of a wireless communication system to which the embodiments of this application are applied. The wireless communication system includes a terminal 11 and a network-side device 12. The terminal 11 may be a terminal-side device, such as a mobile phone, a tablet personal computer, a laptop computer or notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart-home appliance (a smart-home device having a wireless communication function, for example, a refrigerator, a television, a washing machine, or furniture), a game console, a personal computer (PC), a teller machine, or a self-service machine. The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, or the like. It should be noted that a specific type of the terminal 11 is not limited in the embodiments of this application. The network-side device 12 may include an access network device or a core network device, where the access network device may also be called a radio access network device, a Radio Access Network (RAN), a radio access network function, or a radio access network unit. The access network device may include a base station, a Wireless Local Area Network (WLAN) access point, or a Wi-Fi node. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that the same technical effect is achieved, the base station is not limited to a specific technical term. It should be noted that the base station in the NR system is only used as an example in the embodiments of this application for illustration, but a specific type of the base station is not limited. The core network device may include but is not limited to at least one of the following: a core network node, a core network function, a Mobility Management Entity (MME), an Access Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (or L-NEF), a Binding Support Function (BSF), and an Application Function (AF). It should be noted that the embodiments of this application are described with only the core network device in the NR system as an example, but the core network device is not limited to any specific type.

For better understanding the embodiments of this application, the following technical points are first described.

### (1) Introduction to Packet Data Convergence Protocol (PDCP) Function

PDCP supports the following functions:
transfer of user-plane or control-plane data;
maintenance of PDCP Sequence Number (SN);
support in header compression and decompression using a Robust Header Compression (ROHC) protocol;
support in header compression and decompression using an Ethernet Header Compression (EHC) protocol;
ciphering and deciphering;
integrity protection and integrity verification;
timer-based Service Data Unit (SDU) discard;
PDCP PDU routing for split bearer and Dual Active Protocol Stack bearer (DAPS bearer);
PDCP PDU duplication;
in-order delivery of upper layer PDUs during PDCP re-establishment procedure in Radio Link Control (RLC) Acknowledged Mode (AM);
out-of-order delivery; and
duplicate detection of lower layer SDUs during PDCP re-establishment procedure in RLC AM.

### (2) Introduction to RLC Function

RLC supports the following functions:
transfer of upper layer PDUs;
error correction through Automatic Repeat reQuest (ARQ), AM only;
segmentation/resegmentation of RLC SDUs, UM and AM modes only;
reassembly of RLC SDU segments, AM only;
duplicate packet detection, AM only;
RLC SDU discard handling, Unacknowledged Mode (UM) and AM only;
RLC re-establishment; and
protocol error detection, AM only.

### (3) Introduction to MAC Function

MAC supports the following functions:
mapping between logical channel and transmission channel;
multiplexing: multiplexing of MAC SDUs belonging to one or more logical channels into transport blocks of one physical layer transport channel;
demultiplexing: demultiplexing of transport blocks received from a physical layer transport channel into multiple MAC SDUs and sending them to one or more logical channels;
report of scheduling information;
error correction through HARQ;
logical channel priority management;
priority handling between overlapping resources of one terminal; and
radio resource selection.

### (4) Quality of Service and Support Scheme for 5G Vertical Market

Currently, optimization schemes are being explored in the case of higher requirements for service level support in vertical industries within 5G network deployment applications. Typically, for industry customers, the Service Level Agreement (SLA) includes two parts: the business layer SLA and the network layer SLA. The business layer SLA indicators refer to user experience defined from a user business perspective, for example, video stuttering and screen artifacts. Network layer SLA indicators are defined based on 3rd Generation Partnership Project (3GPP) QoS parameter information, and primarily consider user experience data rate, latency, reliability, network availability, or the like. The contents of the current 5G industry white papers are all based on specific industry businesses, and the business layer SLA indicators are mapped to network layer SLA indicators, as shown in detail in FIG. 1B. According to the industry service implementation scheme, the service data such as service generation time and transmission time of different terminals usually have a certain static characteristic or a limited range of variation characteristics.

In 5G industry applications, the mapping between business layer SLA indicators and network layer SLA indicators is usually discussed and performed for each service of each industry user, and existing QoS parameter information may not fully and accurately express the transmission requirements of industry services. The ultimate industry scheme usually adopts a dedicated network approach, to be specific, some or all resources are reserved for industry customers, which is costly.

### (5) 6G Core Services and Vision

According to preliminary industry discussions, the comparison of communication service experience capabilities between 5G and 6G is shown in Table 1. The communication delay of 0.1 ms mainly depends on hardware device and communication protocol design, so the scheme of simplifying the communication protocol is a potential path to reduce the 6G communication delay by an order of magnitude. Therefore, an intelligent/light network is also a widely recognized view in the industry in the China Communications Standards Association (CCSA) 6G project and IMT-2030 discussions.

TABLE 1
Comparison of 5G and 6G communication service experience-related capabilities

| Communication | | 5G | | 6G | |
|---|---|---|---|---|---|
| capability | Definition | requirement | | requirement | |
| Peak rate | Maximum data rate achievable | 20 | Gbps | >100 | Gbps |
| | by each user/device under ideal | | | | |
| | conditions (unit: bit/s) | | | | |
| User experience | Data rate achievable by mobile | 0.1 Gbps to 1 | | >1 | Gbps |
| rate | user/device in target coverage | Gbps | | | |
| | area (unit: bit/s) | | | | |
| Communication | Time span from sending a data | 1 | ms | 0.1 | ms |
| latency | packet at the source to receiving | | | | |
| | a data packet at the destination | | | | |
| | (unit: milliseconds) | | | | |
| Traffic density | Total service throughput | 10 | Mbit/s/m² | 1 | Gbit/s/m² |
| | provided per unit geographic | | | | |
| | region (unit: bit/s/m²) | | | | |
| Connection | Total number of connections | 1/m2 | | 10-100/m² | |
| density | and/or accessible devices per | | | | |
| | unit area (unit: /m²) | | | | |
| Mobility rate | Maximum relative movement | 500 | km/h | 1000 | km/h |

| | | | |
|---|---|---|---|
| | speed between sender and | | |
| | receiver when certain | | |
| | performance requirements are | | |
| | met (unit: Km/h) | | |
| Reliability | Probability of successfully | 0.99999 | 0.9999999 |
| | transmitting a fixed-size data | | |
| | packet within a specified | | |
| | maximum time | | |

6G network services will further enhance existing communication transmission services to support increasingly diverse service transmission needs such as immersive Extended Reality (XR), holographic communication, and multi-dimensional sensory interconnection. In addition, services provided within the 6G network will also be further diversified, expanding from voice and SMS in the related art to include services such as perception and computing. Business layer protocols and communication transmission protocols are both in the design phase, so there is an opportunity for joint design. For extreme service quality requirements, joint design of services and communication transmission can help reduce communication transmission overhead while meeting the same service quality requirements. One of the key issues of the 6G network is how to provide competitive communication transmission services and services within the 6G network with high service quality assurance while simplifying protocol handling to avoid high equipment costs and high energy consumption.

The following describes in detail the data transmission method and apparatus and communication device provided in the embodiments of this application by using some embodiments and application scenarios thereof with reference to the accompanying drawings.

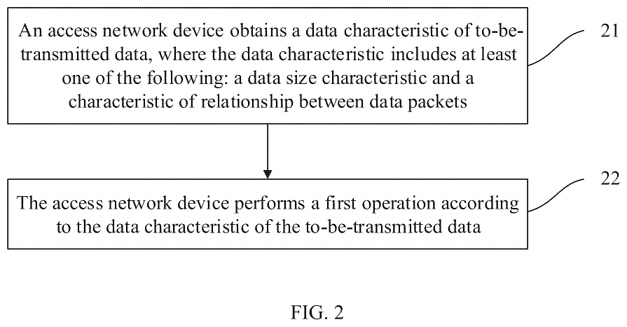

Referring to FIG. 2, an embodiment of this application provides a data transmission method, including the following steps.

Step 21: An access network device obtains a data characteristic of to-be-transmitted data, where the data characteristic includes at least one of the following: a data size characteristic and a characteristic of relationship between data packets.

Step 22: The access network device performs a first operation according to the data characteristic of the to-be-transmitted data.

In the embodiments of this application, a radio access network side may obtain a data characteristic of to-be-transmitted data, and the radio access network side performs a corresponding operation based on the data characteristic of the to-be-transmitted data, for example, simplifying a protocol function and/or scheduling appropriate radio resources to meet data transmission performance requirements.

In this embodiment of this application, the data size characteristic includes at least one of the following:

### (1) A Length of Each Data Packet

For example, the length of each data packet is X bytes. In an embodiment, for services with a constant data packet size, the data size characteristic may be the length of the constant data packet.

### (2) A Maximum Length of Each Data Packet

For example, the maximum length of each data packet is X bytes.

### (3) A Minimum Length of Each Data Packet

### (4) An Average Length of Each Data Packet

### (5) A Collection or Interval Range of Lengths of Each Data Packet

For example, the collection of data packet lengths is {X bytes, Y bytes, Z bytes} for three possible values, or the interval range of data packet lengths is [X bytes Y bytes]. In one embodiment, for services with a limited number of data packet sizes, the data size characteristic may be a collection of data packet lengths, for example, the collection of data packet lengths includes three possible values {X bytes, Y bytes, Z bytes}, or a service control data packet size is 8 bytes, and a service data packet size is 1500 bytes.

(6) A Total Length of Data Packets within a Predefined Time

For example, the data packet length per 10 ms is Y bytes. In one embodiment, for data services with regular data generation, the data size characteristic maybe that the total length of data packets per T time is X bytes.

In this embodiment of this application, the characteristic of relationship between data packets includes at least one of the following:
(1) each data packet is independent (that is, each data packet is self-contained); and
(2) there is an association relationship between data packets.

For example, every N data packets form a service cycle. When Nis 1, it indicates that all data packets of the service are independent with no association relationship; when N is greater than 1, it means that these N data packets are one service cycle, and the next service cycle repeats, for example, three data packets consisting of one control data packet and two service data packets is one service cycle.

For another example, multiple data packets form one piece of complete data that can be parsed by the application layer.

In this embodiment of this application, the association relationship between data packets includes at least one of the following:
there is an association relationship between every predefined number of data packets;
there is an association relationship between data packets within every predefined time; and
there is an association relationship between data packets with a predefined characteristic, for example, there is an association relationship between data packets of size X and data packets of size Y.

In this embodiment of this application, the data characteristic further includes at least one of the following:

### (1) A Data Volume Characteristic

In this embodiment of this application, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

For example, there is a data volume of M bytes within time T, where T does not represent the statistical situation of a service operation interval of a guaranteed bit rate or maximum burst data, instead, it represents a smaller time granularity (such as 100 ms and 10 ms) of service data volume characteristic, and M may mean a static value, maximum data volume, minimum data volume, or average data volume.

### (2) A Data Packet Arrival Time Characteristic

In this embodiment of this application the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

The predefined two data packets may be two consecutive data packets or two non-consecutive data packets.

For example, the arrival time interval of two consecutive data packets is M, where M may be a static value, maximum arrival time interval, minimum arrival time interval, or average arrival time interval, or M may be a sequence representing a relationship between data packet arrival time intervals within one service cycle (that is, distribution information of data packet arrival times).

### (3) A Data Packet Quantity Characteristic

In this embodiment of this application the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

For example, there are M data packets within time T, where M may be a static value, maximum quantity of data packets, minimum quantity of data packets, or average quantity of data packets, or the like.

In this embodiment of this application, that the access network device receives the data characteristic of the to-be-transmitted data includes: the access network device receives the data characteristic of the to-be-transmitted data sent by a core network device. The core network device may be, for example, a Session Management Function (SMF), and the data characteristic of the to-be-transmitted data may be obtained through negotiation between the core network device and the Application Function (AF).

In this embodiment of this application, that the access network device receives the data characteristic of the to-be-transmitted data sent by a core network device includes: the access network device receives QoS parameter information of the to-be-transmitted data sent by the core network device, where the QoS parameter information of the to-be-transmitted data includes the data characteristic of the to-be-transmitted data. Carrying data characteristics through existing QoS parameter information incurs a relatively low cost of change.

In this embodiment of this disclosure, the QoS parameter information may further include at least one of the following:
indication of whether the access network device needs to support retransmission; and
indication of whether the access network device needs to ensure data continuity.

For example, if each data packet of the to-be-transmitted data is independent (that is, each data packet is self-contained), the QoS parameter information may indicate that the access network device does not need to support retransmission. In this case, the access network device establishes a bearer for the to-be-transmitted data, and a protocol processing function of the bearer does not include retransmission, where retransmission includes retransmission at the RLC layer and/or MAC layer.

For example, if there is an association relationship between data packets of the to-be-transmitted data, the QoS parameter information may indicate that the access network device needs to ensure data continuity. In this case, during handover, the access network device needs to perform an operation to ensure data continuity.

In this embodiment of this application, that the access network device receives the data characteristic of the to-be-transmitted data includes: the access network device receives the data characteristic of the to-be-transmitted data sent by a terminal.

In this embodiment of this application, that the access network device receives the data characteristic of the to-be-transmitted data sent by a terminal includes: the access network device receives a Buffer Status Report (BSR) from the terminal, where the buffer status report includes the data characteristic of the to-be-transmitted data. Extending the definition of the existing buffer status report to report data characteristics incurs a relatively low cost of change.

In this embodiment of this application, the data characteristic of the to-be-transmitted data is a data characteristic of a logical channel or a data characteristic of a logical channel group.

The data plane (also known as the target plane) is a newly added protocol plane based on the Control Plane (CP) and the User Plane (UP), and is a protocol function plane for supporting at least one of data collection, data distribution, data security, data privacy, data analysis, and data preprocessing. The data plane may also have other names, and is temporarily referred to as the data plane herein. The data plane may be terminated either in a core network data plane function or a radio access network data plane function.

When the data plane performs wireless data collection or sensing data transmission, the radio access network function is a source of the generated data. The radio access network data plane function determines, based on channel information, cell resource information, or time-frequency resource prediction information of a terminal (User Equipment, UE) (which may be one or more UEs) providing data, a data size transmitted by each UE data plane each time (this size may be TBS or high-level data packet size, for example, PDCP SDU) and/or a data size transmitted by all UE data planes in this cell at a certain time (such as a data size that all UE data planes may transmit in each subframe). Furthermore, the radio access network data plane function may also determine data characteristics such as data volume characteristic, data packet arrival time characteristic, data packet quantity characteristic, or characteristic of relationship between data packets.

In some implementations, that an access network device obtains a data characteristic of to-be-transmitted data includes: the access network device determines a data characteristic of target to-be-transmitted data on a target plane corresponding to a terminal providing the data, where the target plane is a protocol function plane for supporting at least one of data collection, data distribution, data security, data privacy, data analysis, and data preprocessing.

In some implementations, that the access network device determines a data characteristic of target to-be-transmitted data on a target plane corresponding to a terminal providing the data include: the access network device determines, based on channel information, cell resource information, and/or time-frequency resource prediction information of the terminal, the data characteristic of the target to-be-transmitted data on the target plane corresponding to the terminal providing the data, where the time-frequency resource prediction information is information about time-frequency resources that are capable of being allocated to the terminal for transmission on the target plane, within a predicted predefined future time. For example, the predicted resources that can be allocated to UE1 for transmission on the target plane are slots N1, N2, and N3, where the slots N1, N2, and N3 each have M resource blocks. The access network device may determine, based on the channel information of the terminal, a Modulation and Coding Scheme (MCS), and thus may determine that a UE data characteristic transmitted on the target plane is a data size transmitted in slots N1, N2, and N3.

If the data on the data plane is terminated at the core network data plane function, the core network data plane function may send a data characteristic recommendation request such as a data size to a base station before performing data collection or transmission configuration. The data characteristic recommendation request needs to carry identification information of a data-plane transmission channel, so that the base station can optimize a protocol processing function for the identified transmission channel. The base station sends the determined data characteristic to the core network data plane function, and the core network data function may configure the data characteristic of the data plane to the UE. If the data on the data plane is terminated at the radio access network data plane function, the radio access network data plane function sends the configuration of the foregoing data characteristic to the UE and establishes a bearer for data transmission. The optimization for the protocol processing function of the bearer can reduce the functions of segmentation, resegmentation, multiplexing, demultiplexing, or retransmission, and/or scheduled resources are integer multiples of a specified data size.

In some implementations, that an access network device obtains a data characteristic of to-be-transmitted data includes:
the access network device receives a data characteristic recommendation request for to-be-transmitted data on a target plane, sent by a core-network target-plane function; and
the access network device determines the data characteristic of the to-be-transmitted data according to the data characteristic recommendation request; and
after that an access network device obtains a data characteristic of to-be-transmitted data, the method further includes:
the access network device sends the data characteristic of the to-be-transmitted data to the core-network target-plane function, where
the target plane is a protocol function plane for supporting at least one of data collection, data distribution, data security, data privacy, data analysis, and data preprocessing.

Further, during the data plane service, based on a load condition of the radio access network or a change in a UE channel, the radio access network may trigger configuration update of a UE data plane data characteristic. The radio access network directly or indirectly (through the core network data plane function) modifies configuration information of the UE data characteristic to adapt to the preceding network load change or channel change.

In some embodiments of this application, that an access network device obtains a data characteristic of to-be-transmitted data includes:
the access network device receives a data characteristic recommendation request for to-be-transmitted data on a target plane, sent by a terminal; and
the access network device determines the data characteristic of the to-be-transmitted data according to the data characteristic recommendation request; and
after that an access network device obtains a data characteristic of to-be-transmitted data, the method further includes:
the access network device sends the data characteristic of the to-be-transmitted data to the terminal, where
the target plane is a protocol function plane for supporting at least one of data collection, data distribution, data security, data privacy, data analysis, and data preprocessing.

In this embodiment of this application, the performing a first operation includes that: the access network device sends configuration information of a first transmission channel, where the configuration information is used for indicating that the first transmission channel is used for transmitting the to-be-transmitted data, that is, for carrying data with a known data characteristic, and the first transmission channel includes at least one of the following: a Data Radio Bearer (DRB), a Logical Channel (LC), a device measurement result transmission channel, and a data collection transmission channel.

The device measurement result transmission channel is used for transmitting a measurement quantity, and the data collection transmission channel is used for transmitting collected data. The measurement quantity and collected data may be referred to as sensing data.

When the to-be-transmitted data is sensing data (for example, measurement quantity or collected data), the sensing data may not necessarily be transmitted through the user plane (DRB) but may be transmitted through the control plane (SRB) or the target plane (also referred to as the data plane). The target plane is a protocol function plane for supporting at least one of data collection, data distribution, data security, data privacy, data analysis, and data preprocessing.

In some implementations, the device measurement result transmission channel may be represented by a DRB identifier, or may be represented by a Signaling Radio Bearer (SRB) identifier (for example, SRB1, SRB2, SRB3, SRB4), and/or a measurement identifier (for example, Trace ID used by Minimization of Drive Tests (MDT)), or the device measurement result transmission channel may be a newly established channel dedicated to the data plane, represented by an identifier of the data plane transmission channel.

The data collection transmission channel may be represented by a DRB identifier, or by an SRB identifier and/or a data collection identifier (for example, data subscription identity (Identity, ID), or the data collection transmission channel may be a newly established channel dedicated to the data plane, represented by an identifier of the data plane transmission channel.

In some implementations, a first identifier of the first transmission channel is added into the configuration information, where the first identifier is used for indicating whether the data carried by the first transmission channel is data with a known data characteristic.

In this embodiment of this application, the to-be-transmitted data is uplink data, and the performing a first operation includes that: the access network device sends uplink resource scheduling information according to the data characteristic of the to-be-transmitted data, where the uplink resource scheduling information includes at least one of the following:

(1) A transport block size corresponding to the to-be-transmitted data, where the transport block size supports transmission of an integer number of data packets of the to-be-transmitted data.

In some implementations, one transport block size may support transmission of an integer number of known data size data packets (PDU or SDU); for example, one Transport Block Size (TBS) is 3824 bits (478 bytes) and supports transmission of a data packet of a known data size (for example, a data packet size is 472 bytes, with 6 bytes for RAN protocol header overhead); or one transport block size is 3824 bits (478 bytes), and supports transmission of multiple data packets (more than one) within 10 ms (all of these data packets may have the same length or different lengths); for instance, the multiple data packets within 10 ms have three data packet lengths, X, Y, and Z, quantities of the three types of data packets are M, N, and K respectively, and the RAN protocol header overhead is L bytes, so a sum of the lengths of the multiple data packets within 10 ms is (X+L)×M+(Y+L)×N+(Z+L)×K=478; the M+N+K data packets may come from the same logical channel or different logical channels.

In some implementations, when a MAC layer performs scheduling, it needs to consider the data characteristic of the to-be-transmitted data for resource allocation, for example, the TBS indicated by the MAC layer should not be less than a sum of the data size and the RAN protocol header overhead; a higher resource utilization efficiency occurs when TBS equals the sum of the data size and the RAN protocol header overhead or is an integer multiple of that value.

The transport block size corresponding to the to-be-transmitted data may be indicated by the Downlink Control Information (DCI).

(2) A first uplink resource, where the first uplink resource is used for uplink transmission of the to-be-transmitted data.

In this embodiment of this application, in a case that there are multiple uplink transmissions of the to-be-transmitted data, to distinguish the multiple uplink transmissions of the to-be-transmitted data, the uplink resource scheduling information further indicates an identifier of the to-be-transmitted data corresponding to the first uplink resource, where the identifier of the to-be-transmitted data includes an identifier of a DRB or logical channel used to carry the to-be-transmitted data.

In this embodiment of this application, the performing a first operation includes that: the access network device establishes or reconfigures a bearer for the to-be-transmitted data, where a protocol processing function of the bearer does not include at least one of the following functions: segmentation, resegmentation, multiplexing, demultiplexing, and retransmission.

Segmentation refers to dividing one Protocol Data Unit (PDU) data packet into multiple segments, to form multiple Service Data Unit (SDU) data packets. Resegmentation is the inverse process of segmentation of data packets at the receiver, combining the received plurality of segments into one data packet.

Multiplexing refers to multiplexing service data units from one or more logical transmission channels into transport blocks of one physical transmission channel. Demultiplexing is the inverse process of multiplexing at the receiver, demultiplexing the received transport blocks from the physical transmission channel into the multiple service data units. For example, the following two:
MAC multiplexing: multiplexing of MAC SDUs belonging to one or more logical channels into transport blocks of one physical layer transport channel; and
MAC demultiplexing: demultiplexing of the transport blocks received from the physical layer transport channel into multiple MAC SDUs and sending them to one or more logical channels.

Retransmission refers to sending Negative ACKnowledgement (NACK) to the sender for retransmission of not correctly received data, sending positive ACKnowledgement (ACK) for correctly received data to the sender to release data buffer space. For example, for the RLC layer and/or MAC layer,
the RLC layer corresponds to the following function: error correction through ARQ, is AM only; and
the MAC layer corresponds to the following function: error correction through HARQ.

The RLC layer and/or MAC layer of the radio access network need to consider known data characteristic parameters for resource allocation during radio resource management and protocol processing.

If retransmission is not needed, it means for the RLC or MAC of the sender that data may be deleted from the buffer (buffer) after being delivered to the lower layer, but if retransmission is needed, the RLC or MAC needs to wait for correctly transmitting an acknowledgment (ACK) message after delivering the data to the lower layer.

If retransmission is not needed, it means for the RLC or MAC of the receiver only checking whether the data is correctly received (that is, channel decoding or Cyclic Redundancy Check (CRC) is correct), without needing to send ACK or NACK.

For instance, if the data packet is self-contained and does not need retransmission, the RLC layer may not perform ARQ processing, and/or the MAC layer may not perform HARQ processing. The MAC layer not performing HARQ processing means that data may be deleted from the buffer after being sent, without using a HARQ process, and the receiver is instructed not to provide feedback (ACK or NACK) to the sender.

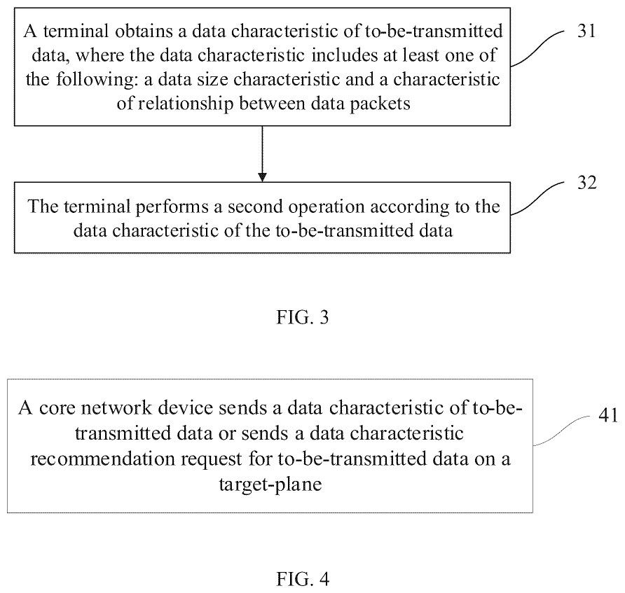

Referring to FIG. 3, an embodiment of this application provides a data transmission method, including the following steps.

Step 31: A terminal obtains a data characteristic of to-be-transmitted data, where the data characteristic includes at least one of the following: a data size characteristic and a characteristic of relationship between data packets.

Step 32: The terminal performs a second operation according to the data characteristic of the to-be-transmitted data.

In this embodiment of this application, the terminal may obtain the data characteristic of the to-be-transmitted data, and the terminal performs a corresponding operation based on the data characteristic of the to-be-transmitted data, for example, notifying a radio access network side, so that the radio access network side performs a corresponding operation, for example, simplifying a protocol function and/or scheduling appropriate radio resources to meet data transmission performance requirements.

In this embodiment of this application, the data size characteristic includes at least one of the following:
a length of each data packet;
a maximum length of each data packet;
a minimum length of each data packet;
an average length of each data packet;
a collection or interval range of lengths of each data packet; and
a total length of data packets within a predefined time.

In this embodiment of this application, the characteristic of relationship between data packets includes at least one of the following:
each data packet is independent; and
there is an association relationship between data packets.

In this embodiment of this application, the association relationship between data packets includes at least one of the following:
there is an association relationship between every predefined number of data packets;
there is an association relationship between data packets within every predefined time; and
there is an association relationship between data packets with a predefined characteristic.

In this embodiment of this application, the data characteristic further includes at least one of the following:
a data volume characteristic;
a data packet arrival time characteristic; and
a data packet quantity characteristic.

In this embodiment of this application, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

In this embodiment of this application, the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

In this embodiment of this application, the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

In this embodiment of this application, that a terminal obtains data characteristic of to-be-transmitted data includes: the terminal receives the data characteristic of the to-be-transmitted data sent by a core network device or an access network device.

In some implementations, that the terminal receives the data characteristic of the to-be-transmitted data sent by a core network device includes: the terminal receives a terminal routing selection policy and/or QoS parameter information of the to-be-transmitted data sent by the core network device, where the terminal routing selection policy and/or the QoS parameter information of the to-be-transmitted data includes the data characteristic of the to-be-transmitted data, and is used for the terminal to associate the data characteristic of the to-be-transmitted data with a QoS flow and a DRB.

In this embodiment of this application, that the terminal performs a second operation according to the data characteristic of the to-be-transmitted data includes: the terminal associates the data characteristic of the to-be-transmitted data with a QoS flow, a DRB, and/or a logical channel.

In this embodiment of this application, that the terminal associates the data characteristic of the to-be-transmitted data with a QoS flow, a DRB, and/or a logical channel includes: the terminal maps the QoS flow of the to-be-transmitted data to a first transmission channel for transmission, where the first transmission channel is used for transmitting the to-be-transmitted data, and the first transmission channel includes at least one of the following: a data radio bearer, a logical channel, a device measurement result transmission channel, and a data collection transmission channel.

In this embodiment of this application, the method further includes: the terminal receives configuration information of a first transmission channel sent by the access network device, where the configuration information is used for indicating that the first transmission channel is used for transmitting the to-be-transmitted data, and the first transmission channel includes at least one of the following: a data radio bearer, a logical channel, a device measurement result transmission channel, and a data collection transmission channel.

In this embodiment of this application, that the terminal performs a second operation according to the data characteristic of the to-be-transmitted data includes: the terminal sends the data characteristic of the to-be-transmitted data to an access network device.

In this embodiment of this application, that the terminal sends the data characteristic of the to-be-transmitted data to an access network device includes: the terminal sends a buffer status report to the access network device, where the buffer status report includes the data characteristic of the to-be-transmitted data. For example, when the terminal finds that a data characteristic size in a buffer during data transmission has a certain data characteristic, the terminal may report the data characteristic and buffer size. The data characteristic may be a data characteristic of a certain logical channel or a data characteristic of a Logical Channel Group (LCG), for instance, the data characteristic is a size of the MAC SDU or PDU with certain regularity. The data characteristic includes at least one of the following: a data size characteristic and a characteristic of relationship between data packets; and may also include at least one of data volume characteristic, data packet arrival time characteristic, and data packet quantity characteristic. For example, the terminal reports a buffer status through a logical channel group ID, a data packet size of X bytes, and buffer size, or reports a buffer status through a logical channel ID, a data packet size of X bytes, and a buffer size. If the radio access network has configured a certain logical channel or logical channel group for the terminal for transmission of data with a known data characteristic, the data characteristic of the to-be-transmitted data may be implicitly indicated by the logical channel ID or logical channel group ID. The buffer status report may be reported through the logical channel ID and the total buffer size or through the logical channel group ID and the buffer size.

In this embodiment of this application, the method further includes: the terminal receives uplink resource scheduling information sent by an access network device, where the uplink resource scheduling information includes at least one of the following:
a transport block size corresponding to the to-be-transmitted data, where the transport block size supports transmission of an integer number of data packets of the to-be-transmitted data; and
a first uplink resource, where the first uplink resource is used for uplink transmission of the to-be-transmitted data.

In this embodiment of this application, in a case that there are multiple uplink transmissions of the to-be-transmitted data, to distinguish the multiple uplink transmissions of the to-be-transmitted data, the uplink resource scheduling information further indicates an identifier of the to-be-transmitted data corresponding to the first uplink resource, where the identifier of the to-be-transmitted data includes an identifier of a DRB or logical channel used to carry the to-be-transmitted data.

Referring to FIG. 4, an embodiment of this application provides a data transmission method, including the following steps.

Step 41: A core network device sends a data characteristic of to-be-transmitted data or sends a data characteristic recommendation request for to-be-transmitted data on a target plane; where the data characteristic includes at least one of the following: a data size characteristic and a characteristic of relationship between data packets; and the target plane is a protocol function plane for supporting at least one of data collection, data distribution, data security, data privacy, data analysis, and data preprocessing.

In this embodiment of this application, the core network device may notify a radio access network side or negotiate with a radio access network side about the data characteristic of the to-be-transmitted data, which helps the radio access network side to perform a corresponding operation, for example, simplifying a protocol function and/or scheduling appropriate wireless resources to meet data transmission performance requirements.

In this embodiment of this application, the data size characteristic includes at least one of the following:
a length of each data packet;
a maximum length of each data packet;
a minimum length of each data packet;
an average length of each data packet;
a collection or interval range of lengths of each data packet; and
a total length of data packets within a predefined time.

In this embodiment of this application, the characteristic of relationship between data packets includes at least one of the following:
each data packet is independent; and
there is an association relationship between data packets.

In this embodiment of this application, the association relationship between data packets includes at least one of the following:
there is an association relationship between every predefined number of data packets;
there is an association relationship between data packets within every predefined time; and
there is an association relationship between data packets with a predefined characteristic.

In this embodiment of this application, the data characteristic further includes at least one of the following:
a data volume characteristic;
a data packet arrival time characteristic; and
a data packet quantity characteristic.

In this embodiment of this application, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

In this embodiment of this application, the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

In this embodiment of this application, the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

In this embodiment of this application, that a core network device sends a data characteristic of to-be-transmitted data includes: the core network device sends QoS parameter information of the to-be-transmitted data to a radio access network device, where the QoS parameter information of the to-be-transmitted data includes the data characteristic of the to-be-transmitted data.

In this embodiment of this application, that a core network device sends a data characteristic of to-be-transmitted data includes: the core network device sends a terminal routing selection policy and/or QoS parameter information of the to-be-transmitted data to a terminal, where the terminal routing selection policy and/or the QoS parameter information of the to-be-transmitted data includes the data characteristic of the to-be-transmitted data.

In this embodiment of this application, after data characteristic recommendation request for to-be-transmitted data on a target plane, the method further includes: the core network device receives the data characteristic of the to-be-transmitted data sent by the access network device.

The following provides illustrative examples of data transmission method in the embodiments of this application with reference to specific application scenarios.

Embodiment 1 of this application A scheme for exchanging a data size characteristic based on QoS parameter information

In this embodiment of this application, information about the data characteristic is added to QoS parameter information, where the data characteristic includes a data size characteristic.

The data size characteristic is different from the existing guaranteed bit rate or maximum data burst volume and may be at least one of the following:

In this embodiment of this application, the data size characteristic includes at least one of the following:

### (1) A Length of Each Data Packet

For example, the length of each data packet is X bytes. In an embodiment, for services with a constant data packet size, the data size characteristic may be the length of the constant data packet.

### (2) A Maximum Length of Each Data Packet

For example, the maximum length of each data packet is X bytes.

### (3) A Minimum Length of Each Data Packet

### (4) An Average Length of Each Data Packet

### (5) A Collection or Interval Range of Lengths of Each Data Packet

For example, the collection of data packet lengths is {X bytes, Y bytes, Z bytes} for three possible values, or the interval range of data packet lengths is [X bytes Y bytes]. In one embodiment, for services with a limited number of data packet sizes, the data size characteristic may be a collection of data packet lengths, for example, the collection of data packet lengths includes three possible values {X bytes, Y bytes, Z bytes}, or a service control data packet size is 8 bytes, and a service data packet size is 1500 bytes.

(6) A Total Length of Data Packets within a Predefined Time

For example, the data packet length per 10 ms is Y bytes. In one embodiment, for data services with regular data generation, the data size characteristic maybe that the total length of data packets per T time is X bytes.

In this embodiment of this application, the data characteristic further includes at least one of the following:

### (1) A Data Volume Characteristic

For example, there is a data volume of M bytes within time T, where T does not represent the statistical situation of a service operation interval of a guaranteed bit rate or maximum burst data, instead, it represents a smaller time granularity (such as 100 ms and 10 ms) of service data volume characteristic, and M may mean a static value, maximum data volume, minimum data volume, or average data volume.

### (2) A Data Packet Arrival Time Characteristic

For example, the arrival time interval of two consecutive data packets is M, where M may be a static value, maximum arrival time interval, minimum arrival time interval, or average arrival time interval, or M may be a sequence representing a relationship between data packet arrival time intervals within one service cycle (that is, distribution information of data packet arrival times).

### (3) A Data Packet Quantity Characteristic

For example, there are M data packets within time T, where M may be a static value, maximum quantity of data packets, minimum quantity of data packets, or average quantity of data packets, or the like.

### (4) A Characteristic of Relationship Between Data Packets

In this embodiment of this application, the characteristic of relationship between data packets includes at least one of the following:
(1) each data packet is independent (that is, each data packet is self-contained); and
(2) there is an association relationship between data packets.

For example, every N data packets form a service cycle. When N is 1, it indicates that all data packets of the service are independent with no association; when N is greater than 1, it means that these N data packets are one service cycle, and the next service cycle repeats, for example, three data packets consisting of one control data packet and two service data packets is one service cycle.

A core network function (for example, SMF) may negotiate the data characteristic with an application function (AF), and based on a negotiation result, the core network function (for example, SMF) sends QoS parameter information containing the negotiated data characteristic to a base station and/or UE, ensuring that an uplink user plane data service with a known data characteristic is correctly classified and tagged to a corresponding QoS flow.

For the service with a known data characteristic, the radio access network may send configuration information of the first DRB or first logical channel. The configuration information is used for indicating that the first DRB or first logical channel is used for transmitting the to-be-transmitted data, to facilitate the mapping of the downlink or uplink QoS flow with a known data characteristic to a corresponding DRB or logical channel for transmission by the base station or UE. In some implementations, a first identifier to the DRB or logical channel is added into the configuration information, where the first identifier is used for indicating whether the data carried by the DRB or logical channel has known data characteristic.

Further, when scheduling, the MAC layer of the radio access network needs to consider a parameter of the known data characteristic for resource allocation. For example, a TBS (transport block size) indicated by the MAC should not be less than a sum of the data size and RAN protocol header overhead. A higher resource utilization efficiency occurs when TBS equals the sum of the data size and the RAN protocol header overhead or is an integer multiple of that value.

For uplink data transmission of UE, the radio access network needs to indicate that the resources are for transmission of uplink data of a known data characteristic when performing uplink resource scheduling. When there are multiple QoS flows or DRBs or logical channels with a known data characteristic, the radio access network may also indicate an identifier of the to-be-transmitted data, for example, using an identifier of the DRB or logical channel carrying the to-be-transmitted data.

In an embodiment, when the data size of the to-be-transmitted data is a constant value, and the data has extremely low delay requirements and no encryption/decryption or integrity requirements, the downlink user plane function (User plane Function, UPF) marks a data packet of the to-be-transmitted data as QoS flow A according to SMF configuration information, and the radio access network maps the data to a logical channel specified by the MAC layer (if using a logical channel, this protocol processing may support multiplexing or demultiplexing of data on multiple logical channels) or to a transport block (TB) based on SMF configuration information. In uplink, UE marks the received data packet of the to-be-transmitted data as QoS flow A according to SMF configuration information, and maps the data to the uplink specified TB according to DCI scheduling information (indicating that the scheduled uplink resource is for data transmission of the known data characteristic) and/or DRB or logical channel information (for example, the uplink data flow as described in the previous paragraph for distinguishing multiple known data characteristics) of the base station.

Embodiment 2 of this application A scheme for reporting a data characteristic based on BSR.

When UE needs to request a resource for uplink data transmission, and the to-be-transmitted data on the UE side has a known data characteristic, the UE needs to report a data size with a certain data characteristic to facilitate better uplink resource scheduling by the network. A potential reporting mode is to extend the definition of BSR for reporting.

When the UE finds that the data characteristic size in the buffer (buffer) during data transmission has certain data characteristic, the UE reports the data characteristic and buffer size (buffer size). The data characteristic may be a data characteristic of a certain logical channel or a data characteristic of a Logical Channel Group (LCG), for instance, the data characteristic is a size of the MAC SDU or PDU with certain regularity. The data characteristic includes at least one of the following: a data size characteristic and a characteristic of relationship between data packets; and may also include at least one of data volume characteristic, data packet arrival time characteristic, and data packet quantity characteristic. For example, the terminal reports a buffer status through a logical channel group ID, a data packet size of X bytes, and buffer size, or reports a buffer status through a logical channel ID, a data packet size of X bytes, and a buffer size.

For this buffer status report, the radio access network needs to consider the known data characteristic for resource allocation when performing uplink resource scheduling, for example, TBS indicated by DCI should not be less than a size of the MAC PDU. A higher resource utilization efficiency occurs when TBS equals the MAC PDU, or is an integer multiple of that value.

In some implementations, if the data characteristic is given, the radio access network may send configuration information of the first DRB or first logical channel. The configuration information is used for indicating that the first DRB or first logical channel is used for carrying data with a known data characteristic, to facilitate the mapping of the downlink or uplink QoS flow with a known data characteristic to a corresponding DRB or logical channel for transmission by the base station or UE. In some implementations, a first identifier to the DRB or logical channel is added into the configuration information, where the first identifier is used for indicating whether the data carried by the DRB or logical channel has known data characteristic.

If the radio access network has configured a certain logical channel or logical channel group for the UE for transmission of data with a known data characteristic, information about the data characteristic of the to-be-transmitted data may be implicitly indicated by the logical channel ID or logical channel group ID. The buffer status report may be reported through the logical channel ID and the total buffer size or through the logical channel group ID and the buffer size.

Embodiment 3 of this application A scheme for exchanging a characteristic of relationship between data packets based on QoS parameter information

In this embodiment of this application, information about the data characteristic is added to the QoS parameter information, where the data characteristic includes the characteristic of relationship between data packets.

In this embodiment of this application, the characteristic of relationship between data packets includes at least one of the following:
(1) each data packet is independent (that is, each data packet is self-contained); and
(2) there is an association relationship between data packets.

For example, every N data packets form a service cycle. When N is 1, it indicates that all data packets of the service are independent with no association; when N is greater than 1, it means that these N data packets are one service cycle, and the next service cycle repeats, for example, three data packets consisting of one control data packet and two service data packets is one service cycle.

For another example, multiple data packets form one piece of complete data that can be parsed by the application layer.

In this embodiment of this application, the association relationship between data packets includes at least one of the following:
there is an association relationship between every predefined number of data packets;
there is an association relationship between data packets within every predefined time; and
there is an association relationship between data packets with a predefined characteristic, for example, there is an association relationship between data packets of size X and data packets of size Y.

The core network function (for example, SMF) may negotiate the data characteristic with an application function (AF), and based on a negotiation result, the core network function (for example, SMF) sends QoS parameter information containing the negotiated data characteristic to a base station, and/or sends QoS parameter information containing the negotiated data characteristic and/or terminal routing selection policy (UE Routing Selection Policy (URSP)) containing the negotiated data characteristic to the UE, ensuring that the uplink user plane data service with the known data characteristic is correctly classified and tagged to the corresponding QoS flow.

For the service with a known data characteristic, the radio access network may send configuration information of the first DRB or first logical channel. The configuration information is used for indicating that the first DRB or first logical channel is used for carrying data with a known data characteristic, to facilitate the mapping of the downlink or uplink QoS flow with a known data characteristic to a corresponding DRB or logical channel for transmission by the base station or UE. In some implementations, a first identifier to the DRB or logical channel is added into the configuration information, where the first identifier is used for indicating whether the data carried by the DRB or logical channel has known data characteristic.

Further, the RLC layer and/or MAC layer need to consider a parameter of the known data characteristic for resource allocation during radio resource management and protocol processing. For instance, if the data packet is self-contained and does not need retransmission, the RLC layer may not perform ARQ processing, and/or the MAC layer may not perform HARQ processing. The MAC layer not performing HARQ processing means that data may be deleted from the buffer (buffer) after being sent, without using a HARQ process (process), and the receiver is instructed not to provide feedback (ACK or NACK) to the sender.

For uplink data transmission of UE, the radio access network needs to indicate that the resources are for transmission of uplink data of a known data characteristic when performing uplink resource scheduling. When there are multiple QoS flows or DRBs or logical channels with a known data characteristic, the radio access network may also indicate an identifier of the to-be-transmitted data, for example, using an identifier of the DRB or logical channel carrying the to-be-transmitted data.

The data transmission method in the foregoing embodiments of this application is applicable to communication systems such as 5G or 6G.

The data transmission method provided in the embodiments of this application may be executed by a data transmission apparatus. In the embodiments of this application, the data transmission method being performed by a data transmission apparatus is used as an example for describing the data transmission apparatus provided in the embodiments of this application.

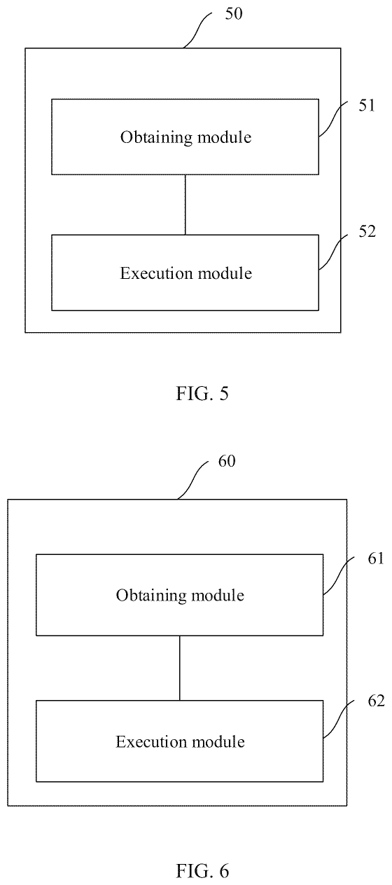

Referring to FIG. 5, an embodiment of this application further provides a data transmission apparatus 50, including:
an obtaining module 51, configured to obtain a data characteristic of to-be-transmitted data, where the data characteristic includes at least one of the following: a data size characteristic and a characteristic of relationship between data packets; and
an execution module 52, configured to perform a first operation according to the data characteristic of the to-be-transmitted data.

In this embodiment of this application, a radio access network side may obtain a data characteristic of to-be-transmitted data, and the radio access network side performs a corresponding operation based on the data characteristic of the to-be-transmitted data, for example, simplifying a protocol function and/or scheduling appropriate radio resources to meet data transmission performance requirements.

In some implementations, the data size characteristic includes at least one of the following:
a length of each data packet;
a maximum length of each data packet;
a minimum length of each data packet;
an average length of each data packet;
a collection or interval range of lengths of each data packet; and
a total length of data packets within a predefined time.

In some implementations, the characteristic of relationship between data packets includes at least one of the following:
each data packet is independent; and
there is an association relationship between data packets.

In some implementations, the association relationship between data packets includes at least one of the following:
there is an association relationship between every predefined number of data packets;
there is an association relationship between data packets within every predefined time;
and there is an association relationship between data packets with a predefined characteristic.

In some implementations, the data characteristic further includes at least one of the following:
a data volume characteristic;
a data packet arrival time characteristic; and
a data packet quantity characteristic.

In some implementations, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

In some implementations, the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

In some implementations, the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

In some implementations, the obtaining module 51 is configured to receive the data characteristic of the to-be-transmitted data sent by a core network device.

In some implementations, the obtaining module 51 is configured to receive QoS parameter information of the to-be-transmitted data sent by the core network device, where the QoS parameter information of the to-be-transmitted data includes the data characteristic of the to-be-transmitted data.

In some implementations, the obtaining module 51 is configured to receive the data characteristic of the to-be-transmitted data sent by a terminal.

In some implementations, the obtaining module 51 is configured to receive a buffer status report sent by the terminal, where the buffer status report includes the data characteristic of the to-be-transmitted data.

In some implementations, the data characteristic of the to-be-transmitted data is a data characteristic of a logical channel or a data characteristic of a logical channel group.

In some implementations, the obtaining module 51 is configured to determine a data characteristic of target to-be-transmitted data on a target plane corresponding to a terminal providing the data, where the target plane is a protocol function plane for supporting at least one of data collection, data distribution, data security, data privacy, data analysis, and data preprocessing.

In some implementations, the obtaining module 51 is configured to determine, based on channel information, cell resource information, and/or time-frequency resource prediction information of the terminal, the data characteristic of the target to-be-transmitted data on the target plane corresponding to the terminal providing the data, where the time-frequency resource prediction information is information about time-frequency resources that are capable of being allocated to the terminal for transmission on the target plane, within a predicted predefined future time.

In some implementations, the data transmission apparatus 50 further includes:
a first receiving module, configured to receive a data characteristic recommendation request for to-be-transmitted data on a target plane, sent by a core-network target-plane function;
a first determining module, configured to receive the data characteristic of the to-be-transmitted data according to the data characteristic recommendation request; and
a first sending module, configured to send the data characteristic of the to-be-transmitted data to the core-network target-plane function, where
the target plane is a protocol function plane for supporting at least one of data collection, data distribution, data security, data privacy, data analysis, and data preprocessing.

In some implementations, the data transmission apparatus 50 further includes:
a second receiving module, configured to receive a data characteristic recommendation request for to-be-transmitted data on a target plane, sent by a terminal;
a second determining module, configured to determine the data characteristic of the to-be-transmitted data according to the data characteristic recommendation request; and
a second sending module, configured to send the data characteristic of the to-be-transmitted data to the terminal, where
the target plane is a protocol function plane for supporting at least one of data collection, data distribution, data security, data privacy, data analysis, and data preprocessing.

In some implementations, the execution module 52 is configured to send configuration information of a first transmission channel, where the configuration information is used for indicating that the first transmission channel is used for transmitting the to-be-transmitted data, and the first transmission channel includes at least one of the following: a data radio bearer, a logical channel, a device measurement result transmission channel, and a data collection transmission channel.

In some implementations, the to-be-transmitted data is uplink data, and the execution module 52 is configured to send uplink resource scheduling information according to the data characteristic of the to-be-transmitted data, where the uplink resource scheduling information includes at least one of the following:
a transport block size corresponding to the to-be-transmitted data, where the transport block size supports transmission of an integer number of data packets of the to-be-transmitted data; and
a first uplink resource, where the first uplink resource is used for uplink transmission of the to-be-transmitted data.

In some implementations, in a case that there are multiple uplink transmissions of the to-be-transmitted data, the uplink resource scheduling information further indicates an identifier of the to-be-transmitted data corresponding to the first uplink resource, where the identifier of the to-be-transmitted data includes an identifier of a DRB or logical channel used to carry the to-be-transmitted data.

In some implementations, the execution module 52 is configured to establish or reconfigure a bearer for the to-be-transmitted data, where a protocol processing function of the bearer does not include at least one of the following functions: segmentation, resegmentation, multiplexing, demultiplexing, and retransmission.

The data transmission apparatus in this embodiment of this application may be an electronic device, for example, an electronic device with an operating system, or may be a component in an electronic device, for example, an integrated circuit or a chip.

The data transmission apparatus provided in this embodiment of this application can implement each process implemented by the method embodiments in FIG. 2, with the same technical effect achieved. To avoid repetition, details are not described herein again.

Referring to FIG. 6, an embodiment of this application further provides a data transmission apparatus 60, including:
an obtaining module 61, configured to obtain a data characteristic of to-be-transmitted data, where the data characteristic includes at least one of the following: a data size characteristic and a characteristic of relationship between data packets; and
an execution module 62, configured to perform a second operation according to the data characteristic of the to-be-transmitted data.

In some implementations, the data size characteristic includes at least one of the following:
a length of each data packet;
a maximum length of each data packet;
a minimum length of each data packet;
an average length of each data packet;
a collection or interval range of lengths of each data packet; and
a total length of data packets within a predefined time.

In some implementations, the characteristic of relationship between data packets includes at least one of the following:
each data packet is independent; and
there is an association relationship between data packets.

In some implementations, the association relationship between data packets includes at least one of the following:
there is an association relationship between every predefined number of data packets;
there is an association relationship between data packets within every predefined time; and
there is an association relationship between data packets with a predefined characteristic.

In some implementations, the data characteristic further includes at least one of the following:
a data volume characteristic;
a data packet arrival time characteristic; and
a data packet quantity characteristic.

In some implementations, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

In some implementations, the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

In some implementations, the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

In some implementations, the obtaining module 61 is configured to receive the data characteristic of the to-be-transmitted data sent by a core network device or an access network device.

In some implementations, the obtaining module 61 is configured to receive a terminal routing selection policy and/or QoS parameter information of the to-be-transmitted data sent by the core network device, where the terminal routing selection policy and/or the QoS parameter information of the to-be-transmitted data includes the data characteristic of the to-be-transmitted data, and is used for the terminal to associate the data characteristic of the to-be-transmitted data with a QoS flow and a DRB.

In some implementations, the execution module 62 is configured to associate the data characteristic of the to-be-transmitted data with a QoS flow, a DRB, and/or a logical channel.

In some implementations, the execution module 62 is configured to map the QoS flow of the to-be-transmitted data to a first transmission channel for transmission, where the first transmission channel is used for transmitting the to-be-transmitted data, and the first transmission channel includes at least one of the following: a data radio bearer, a logical channel, a device measurement result transmission channel, and a data collection transmission channel.

In some implementations, the execution module 62 is configured to send the data characteristic of the to-be-transmitted data to an access network device.

In some implementations, the execution module 62 is configured to send a buffer status report to the access network device, where the buffer status report includes the data characteristic of the to-be-transmitted data.

In some implementations, the data transmission apparatus 60 further includes:
a first receiving module, configured to receive configuration information of a first transmission channel sent by the access network device, where the configuration information is used for indicating that the first transmission channel is used for transmitting the to-be-transmitted data, and the first transmission channel includes at least one of the following: a data radio bearer, a logical channel, a device measurement result transmission channel, and a data collection transmission channel.

In some implementations, the data transmission apparatus 60 further includes:
a second receiving module, configured to receive uplink resource scheduling information sent by the access network device, where the uplink resource scheduling information includes at least one of the following:
a transport block size corresponding to the to-be-transmitted data, where the transport block size supports transmission of an integer number of data packets of the to-be-transmitted data; and
a first uplink resource, where the first uplink resource is used for uplink transmission of the to-be-transmitted data.

In some implementations, in a case that there are multiple uplink transmissions of the to-be-transmitted data, the uplink resource scheduling information further indicates an identifier of the to-be-transmitted data corresponding to the first uplink resource, where the identifier of the to-be-transmitted data includes an identifier of a DRB or logical channel used to carry the to-be-transmitted data.

The data transmission apparatus in this embodiment of this application may be an electronic device, for example, an electronic device with an operating system, or may be a component in an electronic device, for example, an integrated circuit or a chip. The electronic device may be a terminal or may be another device except the terminal. For example, the terminal may include but is not limited to the types of the terminal 11 listed above, and the another device may be a server, a Network Attached Storage (NAS), or the like, which are not specifically limited in the embodiments of this application.

The data transmission apparatus provided in this embodiment of this application can implement each process implemented by the method embodiments in FIG. 3, with the same technical effect achieved. To avoid repetition, details are not described herein again.

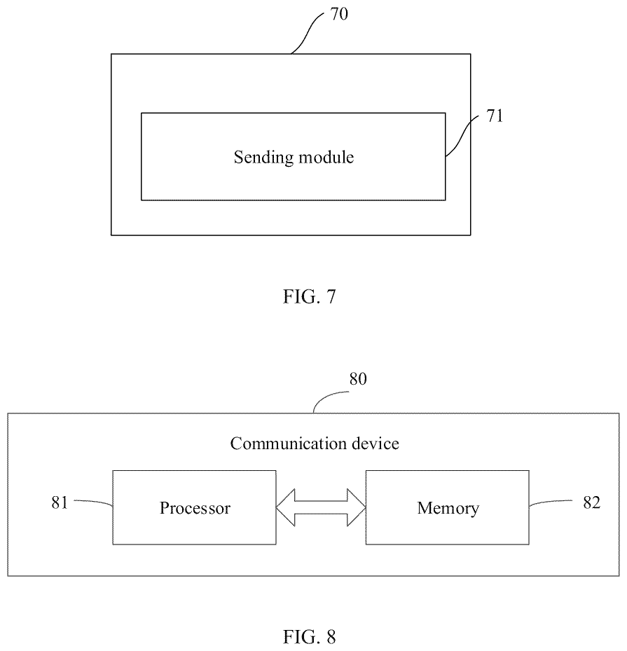

Referring to FIG. 7, an embodiment of this application further provides a data transmission apparatus 70, including:
a sending module 71, configured to send a data characteristic of to-be-transmitted data or send a data characteristic recommendation request for to-be-transmitted data on a target plane; where
the data characteristic includes at least one of the following: a data size characteristic and a characteristic of relationship between data packets; and
the target plane is a protocol function plane for supporting at least one of data collection, data distribution, data security, data privacy, data analysis, and data preprocessing.

The data transmission apparatus in this embodiment of this application may be an electronic device, for example, an electronic device with an operating system, or may be a component in an electronic device, for example, an integrated circuit or a chip. The electronic device may be a terminal or may be another device except the terminal.

The data transmission apparatus provided in this embodiment of this application can implement each process implemented by the method embodiments in FIG. 4, with the same technical effect achieved. To avoid repetition, details are not described herein again.

As shown in FIG. 8, an embodiment of this application further provides a communication device 80 including a processor 81 and a memory 82, where the memory 82 stores a program or instructions capable of running on the processor 81, and when the program or instructions are executed by the processor 81, the steps of the foregoing data transmission method embodiments are implemented, with the same technical effects achieved. To avoid repetition, details are not repeated herein.

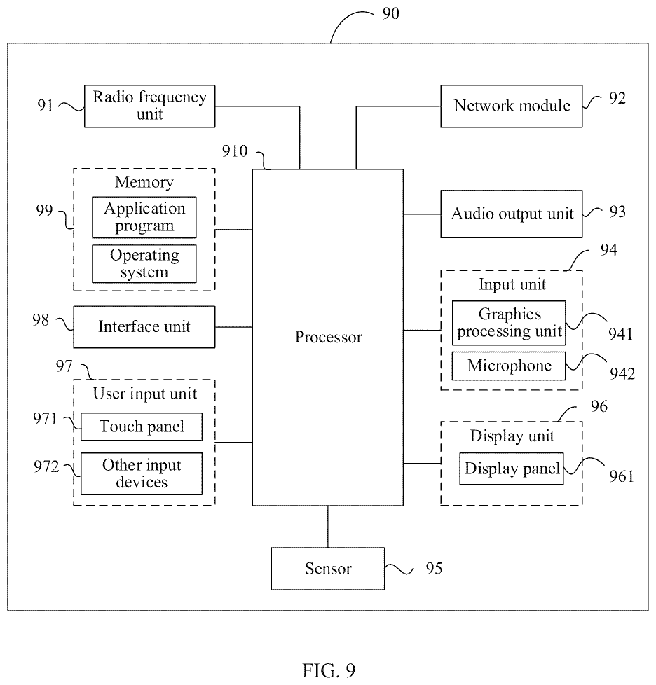

An embodiment of this application further provides a terminal, including a processor and a communication interface, where the processor is configured to: obtain a data characteristic of to-be-transmitted data, where the data characteristic includes at least one of the following: a data size characteristic and a characteristic of relationship between data packets; and perform a first operation according to the data characteristic of the to-be-transmitted data. This terminal embodiment corresponds to the foregoing method embodiment on the terminal side. All implementations in the foregoing method embodiment may be applicable to this terminal embodiment, with the same technical effects achieved. FIG. 9 is a schematic structural diagram of hardware of a terminal for implementing embodiments of this application.

The terminal 90 includes, but is not limited to, at least some of components such as a radio frequency unit 91, a network module 92, an audio output unit 93, an input unit 94, a sensor 95, a display unit 96, a user input unit 97, an interface unit 98, a memory 99, and a processor 910.

Persons skilled in the art can understand that the terminal 90 may further include a power supply (for example, a battery) supplying power to the components, and the power supply may be logically connected to the processor 910 through a power management system. In this way, functions such as charge management, discharge management, and power consumption management are implemented by using the power management system. The structure of the terminal shown in FIG. 9 does not constitute any limitation on the terminal. The terminal may include more or fewer components than shown in the figure, or a combination of some components, or the components disposed differently. Details are not described herein again.

It should be understood that in this embodiment of this application, the input unit 94 may include a graphics processing unit (Graphics Processing Unit, GPU) 941 and a microphone 942. The graphics processing unit 941 processes image data of a static picture or a video that is obtained by an image capture apparatus (for example, a camera) in a video capture mode or an image capture mode. The display unit 96 may include a display panel 961, and the display panel 961 may be configured in a form of a liquid crystal display, an organic light-emitting diode, and the like. The user input unit 97 includes at least one of a touch panel 971 and other input devices 972. The touch panel 971 is also referred to as a touchscreen. The touch panel 971 may include two parts: a touch detection apparatus and a touch controller. The other input devices 972 may include but be not limited to a physical keyboard, a function key (such as a volume control key or an on/off key), a trackball, a mouse, and a joystick. Details are not described herein.

In this embodiment, after receiving downlink data from a network-side device, the radio frequency unit 91 may transmit the downlink data to the processor 910 for processing. In addition, the radio frequency unit 91 may transmit uplink data to the network-side device. Generally, the radio frequency unit 91 includes but is not limited to an antenna, an amplifier, a transceiver, a coupler, a low noise amplifier, and a duplexer.

The memory 99 may be configured to store software programs or instructions and various data. The memory 99 may include first storage area for storing programs or instructions and a second storage area for storing data. The first storage area may store an operating system, an application program or instruction required by at least one function (for example, a sound playback function or an image playback function), and the like. In addition, the memory 99 may include either a volatile memory or a non-volatile memory, or the memory 99 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch Link DRAM, SLDRAM), and a direct rambus random access memory (Direct Rambus RAM, DRRAM). The memory 99 in this embodiment of this application includes but is not limited to these and any other suitable types of memories.

The processor 910 may include one or more processing units. In some implementations, an application processor and a modem processor are integrated in the processor 910. The application processor primarily processes operations relating to an operating system, user interfaces, application programs, and the like. The modem processor primarily processes wireless communication signals, for example, being a baseband processor. It can be understood that the modem processor may alternatively be not integrated in the processor 910.

The processor 910 is configured to: obtain a data characteristic of to-be-transmitted data, where the data characteristic includes at least one of the following: a data size characteristic and a characteristic of relationship between data packets; and perform a second operation according to the data characteristic of the to-be-transmitted data.

In this embodiment of this application, the terminal may obtain the data characteristic of the to-be-transmitted data, and the terminal performs a corresponding operation based on the data characteristic of the to-be-transmitted data, for example, notifying a radio access network side, so that the radio access network side performs a corresponding operation, for example, simplifying a protocol function and/or scheduling appropriate radio resources to meet data transmission performance requirements.

In some implementations, the data size characteristic includes at least one of the following:
a length of each data packet;
a maximum length of each data packet;
a minimum length of each data packet;
an average length of each data packet;
a collection or interval range of lengths of each data packet; and
a total length of data packets within a predefined time.

In some implementations, the characteristic of relationship between data packets includes at least one of the following:
each data packet is independent; and
there is an association relationship between data packets.

In some implementations, the association relationship between data packets includes at least one of the following:
there is an association relationship between every predefined number of data packets;
there is an association relationship between data packets within every predefined time; and
there is an association relationship between data packets with a predefined characteristic.

In some implementations, the data characteristic further includes at least one of the following:
a data volume characteristic;
a data packet arrival time characteristic; and
a data packet quantity characteristic.

In some implementations, the data volume characteristic includes at least one of the following:
a data volume within a predefined time;
a maximum data volume within a predefined time;
a minimum data volume within a predefined time;
an average data volume within a predefined time; and
a collection or interval range of data volumes within a predefined time.

In some implementations, the data packet arrival time characteristic includes at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; and
distribution information of data packet arrival times within a predefined time.

In some implementations, the data packet quantity characteristic includes at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; and
a collection or interval range of quantities of data packets arriving within a predefined time, where the collection includes multiple optional data packet quantities.

In some implementations, the processor 910 is configured to receive the data characteristic of the to-be-transmitted data sent by a core network device or an access network device.

In some implementations, the processor 910 is configured to receive a terminal routing selection policy and/or QoS parameter information of the to-be-transmitted data sent by the core network device, where the terminal routing selection policy and/or the QoS parameter information of the to-be-transmitted data includes the data characteristic of the to-be-transmitted data, and is used for the terminal to associate the data characteristic of the to-be-transmitted data with a QoS flow and a DRB.

In some implementations, the processor 910 is configured to associate the data characteristic of the to-be-transmitted data with a QoS flow, a DRB, and/or a logical channel.

In some implementations, the processor 910 is configured to map the QoS flow of the to-be-transmitted data to a first transmission channel for transmission, where the first transmission channel is used for transmitting the to-be-transmitted data, and the first transmission channel includes at least one of the following: a data radio bearer, a logical channel, a device measurement result transmission channel, and a data collection transmission channel.

In some implementations, the processor 910 is used to send the data characteristic of the to-be-transmitted data to the access network device.

In some implementations, the processor 910 is configured to send a buffer status report to the access network device, where the buffer status report includes the data characteristic of the to-be-transmitted data.

In some implementations, the radio frequency unit 91 is configured to receive configuration information of a first transmission channel sent by the access network device, where the configuration information is used for indicating that the first transmission channel is used for transmitting the to-be-transmitted data, and the first transmission channel includes at least one of the following: a data radio bearer, a logical channel, a device measurement result transmission channel, and a data collection transmission channel.

In some implementations, the radio frequency unit 91 is configured to receive uplink resource scheduling information sent by an access network device, where the uplink resource scheduling information includes at least one of the following:
a transport block size corresponding to the to-be-transmitted data, where the transport block size supports transmission of an integer number of data packets of the to-be-transmitted data; and
a first uplink resource, where the first uplink resource is used for uplink transmission of the to-be-transmitted data.

In some implementations, in a case that there are multiple uplink transmissions of the to-be-transmitted data, the uplink resource scheduling information further indicates an identifier of the to-be-transmitted data corresponding to the first uplink resource, where the identifier of the to-be-transmitted data includes an identifier of a DRB or logical channel used to carry the to-be-transmitted data.

An embodiment of this application further provides a network-side device, including a processor and a communication interface, where the processor is configured to: obtain a data characteristic of to-be-transmitted data, where the data characteristic includes at least one of the following: a data size characteristic and a characteristic of relationship between data packets; and perform a first operation according to the data characteristic of the to-be-transmitted data. The network-side device embodiment corresponds to the foregoing access network device method embodiment. All implementations in the foregoing method embodiment may be applicable to the network-side device embodiment, with the same technical effect achieved.

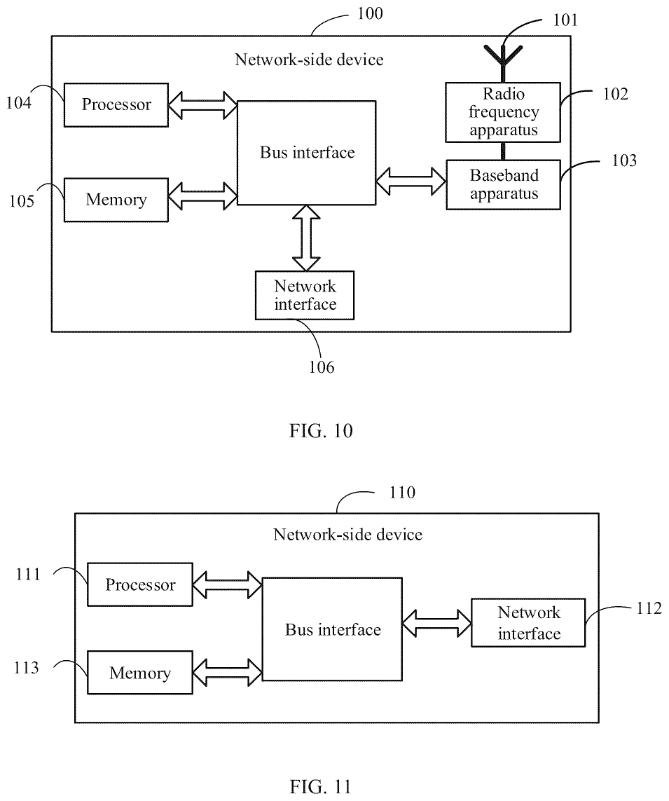

An embodiment of this application further provides a network-side device. As shown in FIG. 10, the network-side device 100 includes: an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and transmits the received information to the baseband apparatus 103 for processing. In a downlink direction, the baseband apparatus 103 processes to-be-sent information, and sends the information to the radio frequency apparatus 102; and the radio frequency apparatus 102 processes the received information and then sends the information by using the antenna 101.

The method performed by the network-side device in the foregoing embodiment may be implemented in the baseband apparatus 103, and the baseband apparatus 103 includes a baseband processor.

The baseband apparatus 103 may include, for example, at least one baseband board, where multiple chips are disposed on the baseband board. As shown in FIG. 10, one of the chips is, for example, the baseband processor, and connected to the memory 105 through a bus interface, to invoke the program in the memory 105 to perform the operations of the network device shown in the foregoing method embodiment.

The network-side device may further include a network interface 106, where the interface is, for example, a Common Public Radio Interface (CPRI).

The network-side device 100 in this embodiment of this application further includes: instructions or a program stored in the memory 105 and capable of running on the processor 104. The processor 104 invokes the instructions or program in the memory 105 to execute the method executed by the modules shown in FIG. 5, with the same technical effects achieved. To avoid repetition, details are not described herein again.

An embodiment of this application further provides a network-side device. As shown in FIG. 11, the network-side device 110 includes a processor 111, a network interface 112, a memory 113. The network interface 112 may be, for example, a CPRI.

The network-side device 110 in this embodiment of this application further includes: instructions or a program stored in the memory 113 and capable of running on the processor 111. The processor 111 invokes the instructions or program in the memory 113 to execute the method executed by the modules shown in FIG. 7, with the same technical effects achieved. To avoid repetition, details are not described herein again.

An embodiment of the present disclosure further provides a readable storage medium, where a program or instructions is stored in the readable storage medium. When the program or instructions are executed by a processor, the processes of the foregoing data transmission method embodiment can be implemented, with same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instructions to implement the processes of the foregoing data transmission method embodiments, with the same technical effects achieved. To avoid repetition, details are not repeated herein.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and the computer program/program product is executed by at least one processor to implement the processes of the foregoing data transmission method embodiments, with the same technical effects achieved. To avoid repetition, details are not repeated herein.

An embodiment of this application further provides a communication system, including an access network device, a terminal, and a core network device, where the terminal may be configured to execute the steps of the data transmission method executed on the terminal side as described above, the access network device may be configured to execute the steps of the data transmission method executed by the access network device as described above, and the core network device may be configured to execute the steps of the data transmission method executed by the core network device as described above.

Persons of ordinary skill in the art may realize that units and algorithm steps of various examples described with reference to the embodiments disclosed in this specification can be implemented by using electronic hardware or a combination of computer software and electronic hardware. Whether the functions are performed by hardware or software depends on particular applications and design constraints of the technical solutions. Persons skilled in the art may use different methods to implement the described functions for each particular application, but it should not be considered that the implementation goes beyond the scope of this disclosure.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, multiple units or components may be combined or integrated into another system, or some features may be ignored or may not be performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on multiple network elements. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

When implemented in a form of a software functional unit and sold or used as an independent product, the functions may be stored in a computer-readable storage medium. Based on such an understanding, the technical solutions of this disclosure essentially or the part contributing to the related art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of this disclosure. The foregoing storage medium includes: any medium that can store program code, such as a USB flash drive, a removable hard disk, a ROM, a RAM, a magnetic disk, or an optical disc.

Persons of ordinary skill in the art may understand that all or some of the processes of the methods in the embodiments may be implemented by a computer program controlling relevant hardware. The program may be stored in a computer readable storage medium. When the program runs, the processes of the method embodiments may be included. The storage medium may include: a magnetic disk, an optical disc, a read-only memory (Read-Only Memory, ROM), or a random access memory (Random Access Memory, RAM).

It should be noted that in this specification, the terms “include” and “comprise,” or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. Based on such an understanding, the technical solutions of this application essentially or the part contributing to the related art may be implemented in a form of a software product. The software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A data transmission method, performed by an access network device, comprising:
obtaining a data characteristic of to-be-transmitted data, wherein the data characteristic comprises at least one of the following: a data size characteristic or a characteristic of relationship between data packets; and
performing a first operation according to the data characteristic of the to-be-transmitted data.

2. The data transmission method according to claim 1, wherein the data size characteristic comprises at least one of the following:
a length of each data packet;
a maximum length of each data packet;
a minimum length of each data packet;
an average length of each data packet;
a collection or interval range of lengths of each data packet; or
a total length of data packets within a predefined time.

3. The data transmission method according to claim 1, wherein the characteristic of relationship between data packets comprises at least one of the following:
each of the data packets is independent; or
there is an association relationship between the data packets.

4. The data transmission method according to claim 3, wherein the association relationship between the data packets comprises at least one of the following:
there is an association relationship between every predefined number of the data packets;
there is an association relationship between the data packets within every predefined time; or
there is an association relationship between the data packets with a predefined characteristic.

5. The data transmission method according to claim 1, wherein the data characteristic further comprises at least one of the following:
a data volume characteristic;
a data packet arrival time characteristic; or
a data packet quantity characteristic.

6. The data transmission method according to claim 5, wherein the data volume characteristic comprises at least one of the following:
a data volume within a predefined time;
a maximum data volume within a predefined time;
a minimum data volume within a predefined time;
an average data volume within a predefined time; or
a collection or interval range of data volumes within a predefined time;
wherein the data packet arrival time characteristic comprises at least one of the following:
a time interval between arrival times of predefined two data packets;
a maximum time interval between arrival times of predefined two data packets;
a minimum time interval between arrival times of predefined two data packets;
an average time interval between arrival times of predefined two data packets; or
distribution information of data packet arrival times within a predefined time; and
wherein the data packet quantity characteristic comprises at least one of the following:
a quantity of data packets arriving within a predefined time;
a maximum quantity of data packets arriving within a predefined time;
a minimum quantity of data packets arriving within a predefined time;
an average quantity of data packets arriving within a predefined time; or
a collection or interval range of quantities of the data packets arriving within a predefined time, wherein the collection comprises multiple optional data packet quantities.

7. The data transmission method according to claim 1, wherein the obtaining a data characteristic of to-be-transmitted data comprises:
receiving the data characteristic of the to-be-transmitted data sent by a core network device.

8. The data transmission method according to claim 7, wherein the receiving the data characteristic of the to-be-transmitted data sent by a core network device comprises:
receiving Quality of Service (QoS) parameter information of the to-be-transmitted data sent by the core network device, wherein the QoS parameter information of the to-be-transmitted data comprises the data characteristic of the to-be-transmitted data.

9. The data transmission method according to claim 1, wherein the obtaining a data characteristic of to-be-transmitted data comprises:
receiving the data characteristic of the to-be-transmitted data sent by a terminal.

10. The data transmission method according to claim 9, wherein the receiving the data characteristic of the to-be-transmitted data sent by a terminal comprises:
receiving a buffer status report sent by the terminal, wherein the buffer status report comprises the data characteristic of the to-be-transmitted data.

11. The data transmission method according to claim 10, wherein the data characteristic of the to-be-transmitted data is a data characteristic of a logical channel or a data characteristic of a logical channel group.

12. The data transmission method according to claim 1, wherein the obtaining a data characteristic of to-be-transmitted data comprises:
determining a data characteristic of target to-be-transmitted data on a target plane corresponding to a terminal providing the data, wherein the target plane is a protocol function plane for supporting at least one of data collection, data distribution, data security, data privacy, data analysis, or data preprocessing.

13. The data transmission method according to claim 12, wherein the determining a data characteristic of target to-be-transmitted data on a target plane corresponding to a terminal providing the data comprises:
determining, by the access network device based on channel information, cell resource information, or time-frequency resource prediction information of the terminal, the data characteristic of the target to-be-transmitted data on the target plane corresponding to the terminal providing the data,
wherein the time-frequency resource prediction information is information about time-frequency resources that are capable of being allocated to the terminal for transmission on the target plane, within a predicted predefined future time.

14. The data transmission method according to claim 1, wherein the obtaining a data characteristic of to-be-transmitted data comprises:
receiving a data characteristic recommendation request for to-be-transmitted data on a target plane, sent by a core-network target-plane function; and
determining the data characteristic of the to-be-transmitted data according to the data characteristic recommendation request; and
after the obtaining a data characteristic of to-be-transmitted data, the data transmission method further comprises:
sending the data characteristic of the to-be-transmitted data to the core-network target-plane function,
wherein the target plane is a protocol function plane for supporting at least one of data collection, data distribution, data security, data privacy, data analysis, or data preprocessing.

15. The data transmission method according to claim 1, wherein the obtaining a data characteristic of to-be-transmitted data comprises:
receiving a data characteristic recommendation request for to-be-transmitted data on a target plane, sent by a terminal; and
determining the data characteristic of the to-be-transmitted data according to the data characteristic recommendation request; and
after the obtaining a data characteristic of to-be-transmitted data, the data transmission method further comprises:
sending the data characteristic of the to-be-transmitted data to the terminal,
wherein the target plane is a protocol function plane for supporting at least one of data collection, data distribution, data security, data privacy, data analysis, or data preprocessing.

16. The data transmission method according to claim 1, wherein the performing a first operation comprises:
sending configuration information of a first transmission channel, wherein the configuration information is used for indicating that the first transmission channel is used for transmitting the to-be-transmitted data, and the first transmission channel comprises at least one of the following: a data radio bearer, a logical channel, a device measurement result transmission channel, or a data collection transmission channel.

17. The data transmission method according to claim 1, wherein the to-be-transmitted data is uplink data, and the performing a first operation comprises:
sending uplink resource scheduling information according to the data characteristic of the to-be-transmitted data, wherein the uplink resource scheduling information comprises at least one of the following:
a transport block size corresponding to the to-be-transmitted data, wherein the transport block size supports transmission of an integer number of data packets of the to-be-transmitted data; or
a first uplink resource, wherein the first uplink resource is used for uplink transmission of the to-be-transmitted data.

18. The data transmission method according to claim 17, wherein when there are multiple uplink transmissions of the to-be-transmitted data, the uplink resource scheduling information further indicates an identifier of the to-be-transmitted data corresponding to the first uplink resource, wherein the identifier of the to-be-transmitted data comprises an identifier of a Data Radio Bearer (DRB) or logical channel used to carry the to-be-transmitted data.

19. The data transmission method according to claim 1, wherein the performing a first operation comprises:
establishing or reconfiguring a bearer for the to-be-transmitted data, wherein a protocol processing function of the bearer does not comprise at least one of the following functions: segmentation, resegmentation, multiplexing, demultiplexing, or retransmission.

20. A data transmission method, performed by a terminal, comprising:
obtaining a data characteristic of to-be-transmitted data, wherein the data characteristic comprises at least one of the following: a data size characteristic or a characteristic of relationship between data packets; and
performing a second operation according to the data characteristic of the to-be-transmitted data.

21. A communication device, comprising:
a memory storing computer-readable instructions; and
a processor coupled to the memory and configured to execute the computer-readable instructions, wherein the computer-readable instructions, when executed by the processor, cause the processor to perform operations comprising:
obtaining a data characteristic of to-be-transmitted data, wherein the data characteristic comprises at least one of the following: a data size characteristic or a characteristic of relationship between data packets; and
performing a first operation according to the data characteristic of the to-be-transmitted data.
